(19) United States
(12) Patent Application Publication
(10) Pub. No.: US 2017/0230172 A1
(43) Pub. Date: Aug. 10, 2017

(54) Key agreement algorithm for cipher key creation over a public channel

(71) Applicant: Kåre Lars, Magnus Andersson, Svenshögen (SE)

(72) Inventor: Kåre Lars, Magnus Andersson, Svenshögen (SE)

(21) Appl. No.: 15/019,667

(22) Filed: Feb. 9, 2016

(51) Int. Cl. H04L 9/08

(52) U.S. Cl. CPC H04L 9/0841; H04L 9/0869

(57) ABSTRACT

Two parties will engage in encrypted data communicating over a non secure channel. The encryption require a common session or consecutively updated key, not known by anybody else, and established without prior secrets. One of the parties, the initial sender, creates a table of multiple equations. Each equation contains parameters, known only by him, variables set to different values for different equations, and a solution. Each equation is true. He sends the information to the initial receiver who uses the original equations to form multiple new ones, thereby obfuscating their origin. The initial receiver keeps the solution side secret and return only the variable parts of his new equations. The initial sender receives the new equations and uses his hidden parameters to calculate the solutions. The solutions will now be known by the two communicating parties, but not easily available for an unauthorized interceptor of the communication.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Field of the Invention

The present invention relates to information security in general, more particularly to cryptography and the use of asymmetric schemes to enforce secrecy over a non secure channel without support of prior secrets. The nature of the invention in its optimal setup is pre-message in itself, only establishing a secret information pool, although there are applications which introduces integrated messaging routines into the scheme. The use of such a information pool as a key for cipher creation helps in preventing unauthorized use or access of information during its transfer and storage, thereby maintaining the secrecy and integrity of information exchanged over a (digital) network.

Description of the Related Art

Cryptography is the science of protecting information from eavesdropping and interception, encoding messages or information in such a way that only authorized parties can read it. Encryption facilitates the secure management of data by scrambling the content. The two principle objectives are secrecy (to prevent unauthorized disclosure) and integrity (to prevent unauthorized modification). A number of techniques are known to provide this protection, and the nature of the area also makes it preferable with multiple alternatively methods of handling. Encryption does not of itself prevent interception, but hides the content of the message from the interceptor. In an encryption scheme, the message intended for communication is encrypted by use of an encryption algorithm, generating cipher text that can only be read if decrypted. To adapt to the nature of the message, developing necessary substance from a key, an encryption scheme usually uses a pseudo-random algorithm. It is in principle possible to decrypt the message without possessing the key, but, for a well-designed encryption scheme, large computational resources and skill will then be required. An authorized recipient can easily decrypt the message with the key provided by the originator to recipients. Symmetric schemes is the old way to approach the need for protection of information and these schemes can be constructed in a virtually endless number of ways, but their limiting feature is the need for the sender and the receiver to share a common key. The problem is to distribute that key to the sender and the receiver in a way that prevents eavesdropping. Asymmetric keys are the common answer to that problem. Asymmetric encryption is based on a key pair, one secret key for decryption and one open key for encryption. The open key will be of no use for decryption which is what's bypassing the limits of symmetric encryption.

The following scenario lies implicit. An primary actor creates a pair of keys, whereof one is private and the other one is public. A secondary actor who wants to convey a confidential message to the primary actor uses the public key to encrypt the message, which is subsequently sent. The primary actor now uses his private key to decrypt the message. In this scenario, only the primary actor has any part of the creation of the keys. Already in the third phase of interaction, a natural language message can be conveyed. Depending on the type of communication, asymmetric schemes of this type can be used to establish a common session key between the primary and secondary actor, which is then replacing the natural language message as the first message. In that case the scenario will look like this: The primary actor sends a copy of his asymmetric public key. The secondary actor creates a symmetric session key and encrypts it with the primary actor's asymmetric public key. He then sends the symmetric session key to the primary actor. The primary actor decrypts the encrypted session key using his asymmetric private key to get the symmetric session key. The primary and secondary actor now are able to encrypt and decrypt all transmitted messages with the symmetric session key. The most important method to achieve this scheme is the RSA method. The asymmetric to symmetric approach is commonly used for interchanging data sessions between two parties, for instance over Internet. The reason for the switch to a symmetric solution from an asymmetric one is that these two solutions accomplish two different things. The initial, asymmetric scheme allows a buildup of a secret information pool, common for the primary and the secondary actor, over a non secure medium, which pool is used as a session key. No previous secrets between the parties are needed. The symmetric solution achieves a higher level of security for the subsequent data exchange per data. The computational costs are also significantly lower for a symmetric solution. A second major asymmetric approach to accomplish the buildup of a secret information pool between a sender and a receiver, or a group of inter messaging parties, is the Diffie Hellman algorithm. The Diffie Hellman algorithm is a key agreement algorithm and most key agreement algorithms are also related to this specific algorithm in one way or another. In the methodology, the Diffie Hellman algorithm is symmetric, in that the steps of action on each side is equal, but the content sent is asymmetric. The factual method for two participants looks like this. First actor A and actor B openly agrees on the use of two large prime numbers, pf and pm. These can in practice be attached to the first message. Both parties now choose one secret, large prime number on each side, pA and pB. A now computes pf^{pA} mod pm and send the result to B, while B computes pf^{pB} mod pm and send the result to A. Then A calculates (pf^{pB} mod pm)^{pA} while B calculates (pf^{pA} mod pm)^{pB}, which operations both will give the same result, namely pf^{pApB}. This value will then be used as a shared, secret information pool (key) for further symmetric encryption. The underlying, mathematical problem for the Diffie Hellman algorithm and RSA is the same, namely prime factorization. The fastest way to solve the problem of prime factorization is often said to be the General number field sieve. Therefore, the security aspect, the data to security ratio is similar for the two methods. Both methods are also computationally expensive. There are also asymmetric key systems in use, which do not rely on prime number. Examples hereof is NTRUEncrypt, Elliptic curve cryptography, Hidden Fields Equations and McEliece cryptosystem. Their common feature is that they are built around mathematical problems which are of a high level of complexity.

A solution based on asymmetric keys is generally said to be 200-1000 times as costly computationally as a symmetric solution. Regarding its need for more information resources to accomplish a specified level of security, the cost of for instance a message exchange keyed with RSA, which is widely used, will approach 25 times the cost of an symmetrically, 128 bits keyed exchange with the same real information content. For higher security levels this ratio will rapidly go even higher. It would then be a significant improvement with a scheme that allows formation of keys of symmetric session type or consecutive nature, over an insecure medium, without prior secrets, and without the high costs associated with previously known asymmetric key techniques.

### BRIEF SUMMARY OF THE INVENTION

The present invention is an approach to be able to solve the issue of having to establishing a first or successive shared secret between a sender and a receiver over an non secure channel, supposedly available for everyone, in the fastest and most secure manner possible.

### DESCRIPTION OF THE DRAWINGS

For a more complete understanding of the present invention, reference is now made to the following descriptions:

FIG. 1 The environmental settings for the description.

FIG. 2 The three principal phases which are parts of the method.

FIG. 3 Access the different parts of the matrix.

FIG. 4 The continuation of access the different parts of the matrix.

FIG. 5 Provides a detailed, exemplified view of the primary phase, with the preparations of the initial sender.

FIG. 6 Shows the same example operated by the initial receiver in the secondary phase from before.

FIG. 7 A view over the retrieval of the solution point i.e the tertiary phase from before.

FIG. 8 Shows the view of a hacker.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

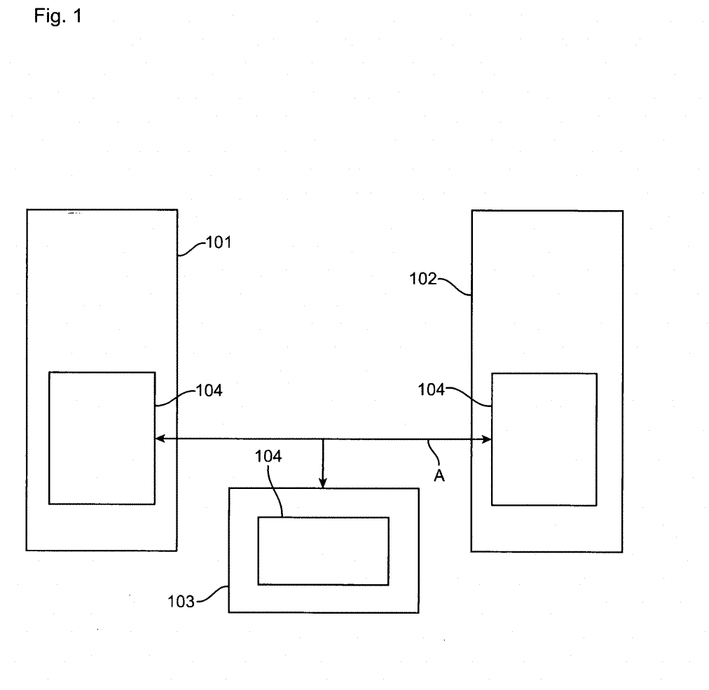

Referring to FIG. 1 in which is seen the environmental settings for the description. Here is illustrated (101) the participation of an initial sender machine node, and likewise (102) the participation of an initial receiver machine node, engaging in (A) communication by means of a data transmission system. This system is unsafe, meaning that any exchange of information will always have to take in account the possibility of (103) any number of unauthorized parties, i.e hackers trying to intercept the communication in various ways. The primary agreements for communication are open by integration in an (104) public application which is expected to be available for the initial sender and the initial receiver as a ruleset for understanding, but by consequence of its public nature also for any hacker.

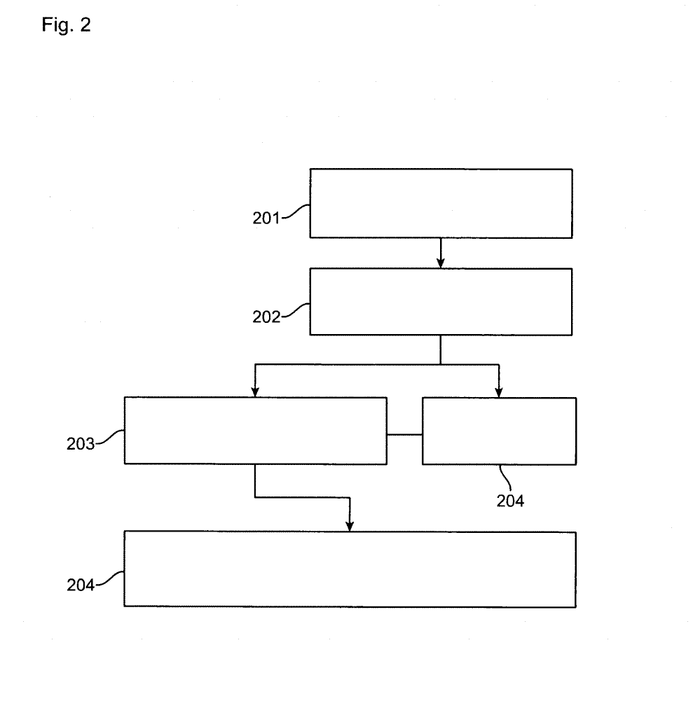

The procedure of the method described proceeds over three phases, schematized in FIG. 2. There are three principal phases shown which are parts of the method, presuming necessary connections have been established. The primary phase (201) starts with the initial sender constructing a table of equations. The preferred implementation hereof will later be shown as binary tables, as this is likely to render the highest information density possible. Also, a design which implies all equations (and parameter set) to be of equal length will allow the highest level of obfuscation and security later shown, and will therefore be anticipated in this description. Each equation here described consists of one variable set, i.e a series of binary variables, added together without carry, a boolean operation known as XOR, and its solution, a single binary. So each variable is a binary and it will also be multiplied with another binary, a parameter, before it and all other variables of the equations are added together by XOR. This means that some variables are irrelevant for the equations, namely those which are multiplied with 0 beforehand. Only variables multiplied with 1 will be relevant and they will sum together to form the solution. The parameter set and the variable set will therefore be of equal length. The table constructed by the initial sender will list an entire series of equations, each consisting of variables, which, position by position, are multiplied with one and the same parameter set, after XOR resulting in one single bit solution for each equation.

The entire table with variables and solutions, but without any parameters, will at this point be sent to the initial receiver, whose actions form the secondary phase (202) in the figure. The initial receiver will continue the process by active participation in the creation of a symmetric key, which will then be used. This is the most information efficient scheme. His objective is to create a new table of obfuscated equations with solutions, at a glance looking like some variant of the table already sent to him. Each obfuscated equation must be merged together from a randomly chosen sample of the original equations. The choice of original equations participating in any sample founding one obfuscated, new equation, is totally independent of all other samples of choice for the rest of the table he is about to create. All original equations is of equal length with one solution, which allows him to add each variable by position for every equation in the sample together with all the others, using XOR. Within each original equation, no operation is therefore performed between different positions. So all no. 1 position variables in his sample is merged together separately, all no. 2 position variables in the same sample are merged together separately, and so on. The solutions in his sample is merged together the same way. This will work because XOR is analogous to sum modulo 2, which sums up the 1:s from any number of equations, followed by modulo 2. Thus the operations on the variable side and the solution side are confirmative to each other. By repeating the merge for each of his sample, the initial receiver reaches his goal of constructing a new table of obfuscated equations.

Since, the solutions of this will constitute a new, symmetric key to use in combination with any independent protocol. Therefore there will be applications where the initial receiver is already using some symmetric scheme to encrypt a real language message or similar, based on this key. In FIG. 2 this choice is shown by the outgoing arrow splitting and going into the right rectangle below.

A third choice, not easily shown in the figure, is that the initial receiver now in parallel with his obfuscated table and a cipher also will send an entirely new, original table of completely independent equations, thereby acting “initial sender” in overlapping, consecutive scheme. This way, there will be no standing session key at all. Each symmetric key will be used only to encrypt and decrypt one single message. The initial receiver could even skip any use of symmetric keys and simply choose obfuscated equations to form a returning message, but because this do not allow independent parameter set to hide many solutions per equations, it will be of less practical value. The increased need for bandwidth is not motivated.

In any case, he will keep the solutions private, and return only the variable setup from his new table to the initial sender. The handling of the initial sender upon this returning information constitutes the tertiary phase (203) in the figure. The initial sender are now able to use the secret parameters of this, saved from start, to solve each obfuscated equation in the table. Because his way of obtaining these solutions are different from how the initial receiver got them, they are not easily available for any hacker. They therefore make up the common, symmetric key for the parties communicating. If there is a cipher attached to the returning table the initial sender will now be able to instantly use the key to solve it. Else the session of interaction by a symmetric scheme of choice will begin at this point, which is the communication phase (204).

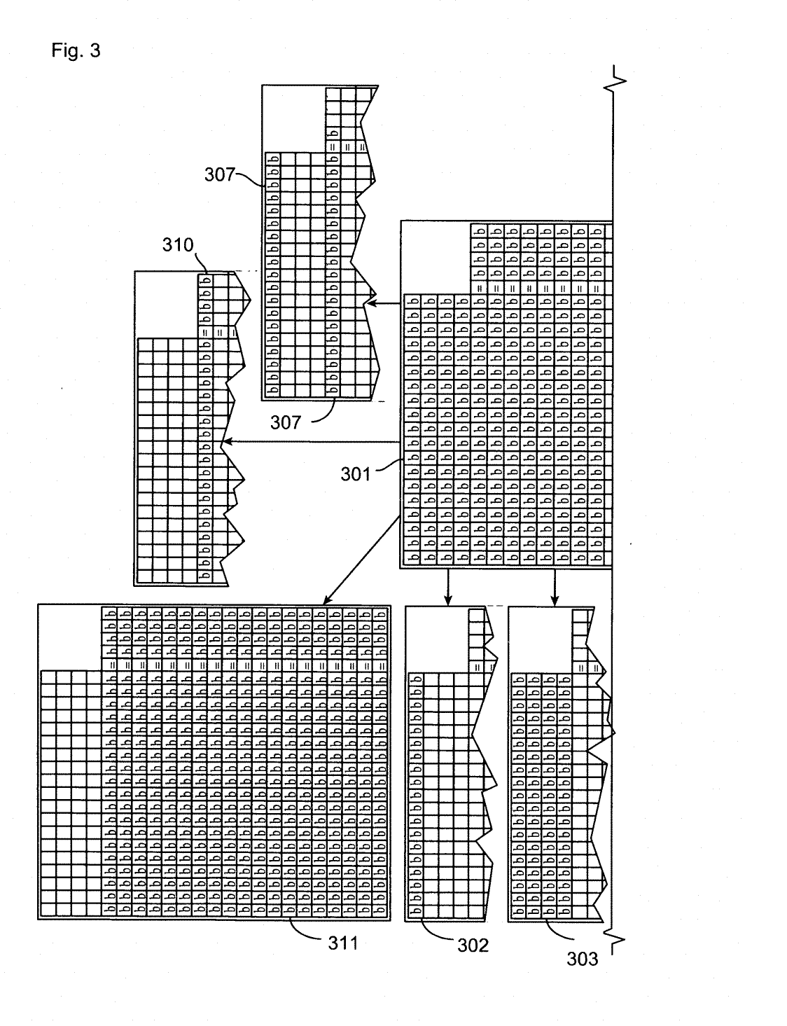

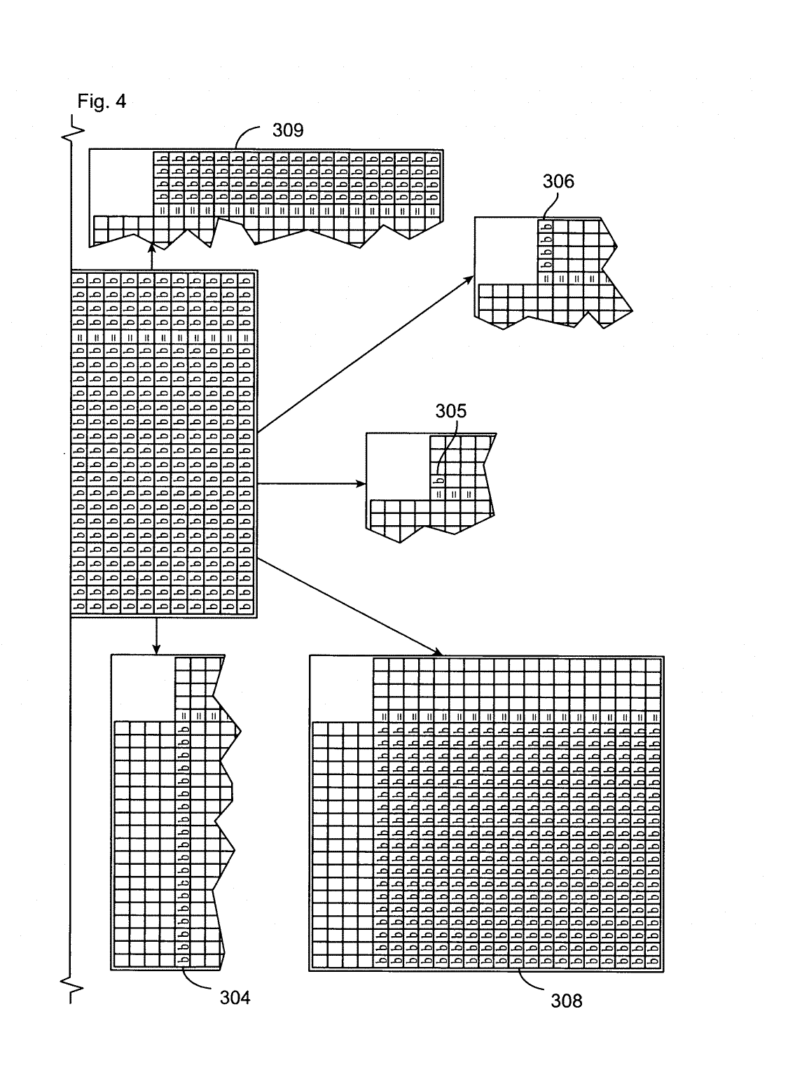

In order to proceed to an example, first look at FIG. 3 and FIG. 4 to access the different parts of the matrix (the drawing in FIG. 4 is a continuation of the drawing in FIG. 3). The matrix can be pictured in many ways not shown here, for instance turned 90 degrees right and so on. The entire, filled matrix is shown as (301) also showing the empty right, upper corner, visible in all views. The initial sender's secret part of any equation is the parameterline (302). For practical purposes, multiple, independent parameterlines will be used, making up an entire parametertable (303). One single parameterline applied to a variableline (304) will equal one single solutionpoint. By (305) one example of a solutionpoint out of many is shown. An entire parametertable applied to an variableline will equal a solutionline (306). One single parameterline applied to a variableline, corresponding to a solution bit will make up an equationtotal (307). Multiple variablelines of equal length will form a variabletable (308). An entire parametertable applied to each of the equations in a variabletable will equal a solutiontable (309). The non secret part of each equationtotal which is sent from the initial sender to the initial receiver, but with all solutions included, is called an equation (310). The entire packet of equations sent will make up an equationtable (311).

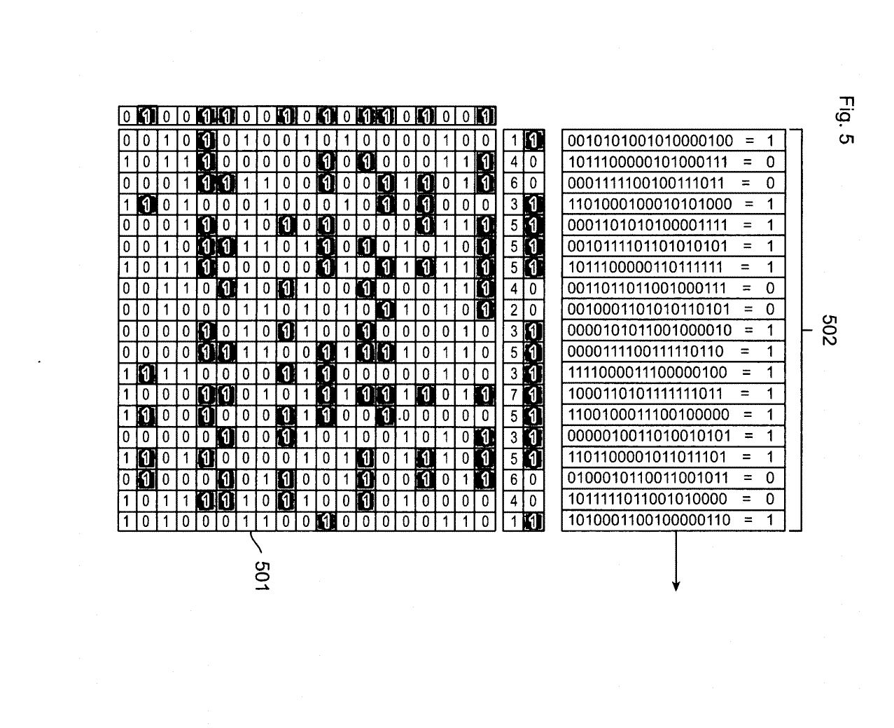

FIG. 5 provides a detailed, exemplified view of the primary phase, with the preparations of the initial sender. A one parameterline only matrix, to easify understanding, is shown by (501) where intermediate sums on each rows are displayed before respective solution to the right. The choice of a 19×19 matrix is for illustration purposes only. The matrix is filled with binaries, beginning with random values for the parameterline and the variabletable. The random act of filling up the variabletable (only), can be replaced with a pseudo-random process, derived from a seed. If the initial sender and the initial receiver have a, non secret, pseudo-random generator in common, shared within the application, only the seed of the variabletable needs to be sent, saving bandwidth. The solutions still must be sent as non simplified information. For a hacker it will at this point be necessary to recreate the parametertable for any further conclusion, which for large tables will be virtually impossible. There are 2^{N} ways to pick a parameterline for an table of N variable positions. The non simplified information for this example is shown as (502) which is sent to the initial receiver.

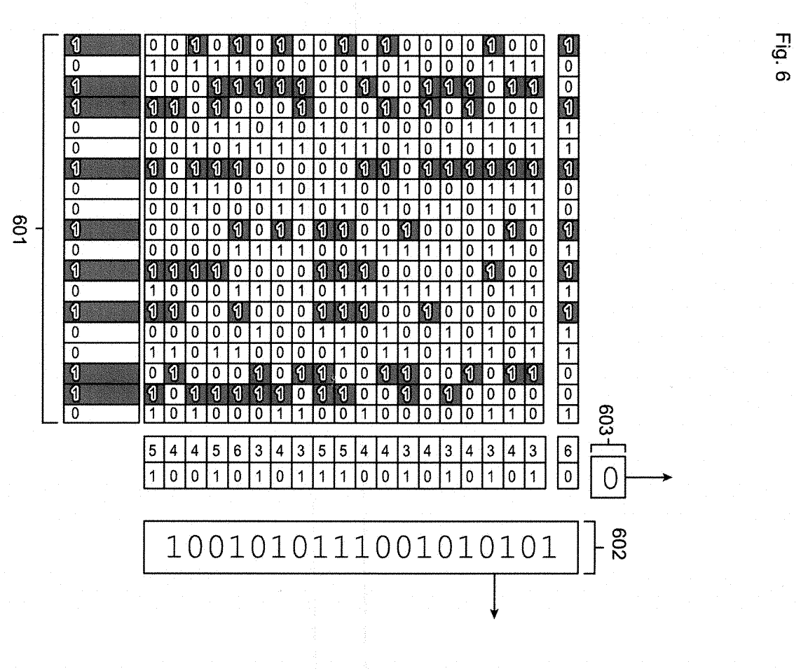

FIG. 6 shows the same example operated by the initial receiver in the secondary phase from before. If an random-number generator is used, the table is rendered as a function of the generator acting on the seed received. By (601) is shown the equationtable, where equations of choice, hereby picked by the initial receiver, are marked according to the left column, illustrating every picked equation with an 1. The act of picking equations is an act of preferred randomness, equal to how the initial sender picked his parameters in former phase. The outcome of XOR operating over each position of the picked equations are shown at the bottom, with an intermediate sum displayed for each column. To the right the identical operation is performed over the solutions. The solution will never be sent. The information sent is shown as (602) and comprises one variableline for this example. The solutionpoint (603) is kept as part of the secret information pool. This means any third person, i.e man in the middle, cannot get hold of the solutionpoint without trying to find the original equations via brute force testing. Analogous to guessing the parameterline of the initial sender, this may take practically infinite time as there is again 2^{M} ways to obfuscate M original equations into a new one. In order to build a full information pool common for the initial sender and the initial receiver the latter will have to return an entire new, obfuscated variabletable, and therefore to repeat this step multiple times, ending up with multiple, independent, obfuscated equations of which the variabletable is returned but the solutiontable is kept secret.

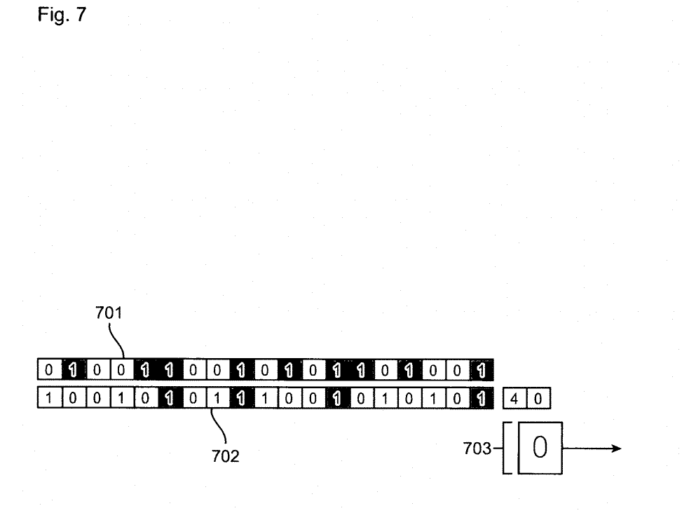

FIG. 7 is a view over the retrieval of the solutionpoint i.e the tertiary phase from before. The initial sender have now got the variableline from the initial receiver. The parameterline from 501 is picked up and marked as (701). This secret information is applied on the variableline by boolean AND as for any of the original equations. The active variables of the equation are now summed together, displayed as an intermediate, after which modulo 2 is performed, i.e XOR over the length of the active variableline. The initial sender has now retrieved the identical solutionpoint (703) as the initial receiver added to his secret information pool as (603) before. The use of boolean NOT can be employed as a last operation possibility for the primary and secondary phase. This is analogous to imply a N+1 column in the former phase, using only XOR, where the last position of all variablelines is 1. The parameter is either 0 or 1. In the latter phase it is analogous to a M+1 equation with all variable positions occupied by 1, also using only XOR. However the solutionpoint then needs to be known which reveals the parameter of choice for the N+1 position in the former phase where NOT was formerly used, for a hacker. For the last phase, if the former mentioned parameter choice is implied, this still leaves the possibility of a doubled number of possible permutations for the same amount of information transferred. Intermingled operations with NOT and XOR are possible but will result in no more permutations as 2 NOT also in different stages cancels each other.

Presume use of boolean NOT over both phases. In the primary phase NOT is implied as an N+1 extra column while looked at as reversal of all bits in the secondary phase, for the sake of clarity. The initial sender randomly sets his parameter for N columns, as usual. If the number of 1:s in the parameterline is odd, the extra column parameter is set to 0. If the number of 1:s in the parameterline is even, the extra column parameter is set to 1. This means that the real number of 1:s for the entire parameterline, and therefore the number of active variablecolumns, will always be odd. The initial sender sends all equations to the initial receiver as usual. Now the initial receiver is able to employ NOT as a last step of any obfuscated equation. As the number of active variables are odd it means that it any variableline will either contain an odd number of 1:s and an even number of 0:s or vice versa. Negation over the entire variableline will therefore turn an odd number of 1:s into an even numbers of 1:s (former 0:s) and an even number of 0:s into an odd number of 0:s (former 1:s), or vice versa. The operation of NOT can be employed over the variablepoint (variableline) as well, why it is a equality preserving operation for any entire equation.

It is preferable that an application, using the scheme, includes use of an entire parametertable. In reality, only the equationtotal expresses full equivalence. This means that within the matrix of the initial sender, each of the parameterlines will act independently on the entire variabletable, engaging in M equationtotals for a table of M equations, resulting in one column in the solutiontable. Next parameterline in the parametertable will again act independently of the former, enforcing a new combination of columns in the variabletable, resulting in a new column in the solutiontable. The entire equationtable, including the solutiontable, is sent to the initial receiver. The initial receiver will now construct a new, obscured equation from the ones sent. He will perform XOR over each column in the solution table, meaning that each obscured equation of his will correspond to not only one single bit of secret information, but multiple. This will be the most effective way to create secret information out of a limited amount of public information.

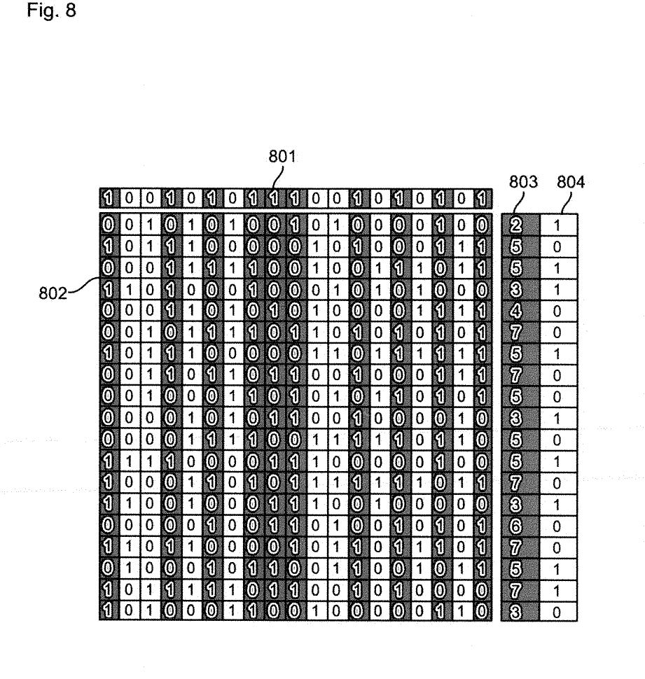

FIG. 8 shows the view of a hacker, trying to find the original equations which resulted in the obfuscated variableline in our example (801), sent from the initial receiver. The hacker has also collected the original equations (802) sent by the initial sender and put the variabletable into his matrix. The solutiontable is not shown as it will be used only if the hacker is successful in finding the original variablelines used for the merge. Presume for demonstration purposes that NOT is never used. NOT will only result in him having to take into account an inverted variabletable as well. We will now assume that the hacker don't want to use brute force, but is trying to find a shortcut. One way would be to target rows with clustered 1:s for relevant columns. This would be to go for the fact that an obfuscated equation with a 1 in a position must have an original equation with an 1 on the same column. The column of sums (803) exemplify the output. If we compare this with (804) which is the solution the hacker searches for, but doesn't have, no such pattern occur, evident enough to save any real amount of computer power. Another way would be to perform a systematic hacking search, based on columns with a 1 in (801). These variablelines can be merged into a combinatorial testing scheme. This would mean only about half of the columns (obscure eq 1:s) would need consideration as well as only half of the rows for that column. But we can't eliminate even numbers of 1:s for that column, as the numbers interfere with the sums for other columns. Thus each of these positions can be either 0 or 1. We ends up with a permutation number which is obviously higher than 2¹⁹. So these kind of schemes will not help a hacker.

Leaving the Fig, a third consideration must be whether or not a brute force hacker is likely to stumble into some kind of other combination which works as well. For a table of the exemplified size, as to be expected for a quadratic table of any size, the average number of multiplets which makes a hit is 2. A brute force calculation for this small table will reveal this is true here, where try 365222 and try 524288 makes up combinatoric solutions and where 365222 is the variableline sent by the initial receiver as a binary number. As any solution will lead to working, original equations with enclosed solutions, this means a hacker will in average only do ⅔ the amount of tests he would otherwise have to do, to solve the problem. If the solutiontable is used as seed for a good, symmetric algorithm the hacker needs in principle all of it to put into the algorithm. This means he can't stop with his first hit but has to proceed down the path to solve further obfuscated equations. How many equations or how many parameter bits? In order to reach further conclusions the question of optimal number of parameterlines from a bandwidth/security perspective needs to be answered, easiest by looking at the extremes. One extreme is when only 1 parameterline is used. This means the primary sender is saving a lot of bandwidth as he only has to send effective solutions along with a seed for the common pseudo number generator. If the matrix is 256×256 lines times rows he send the seed, for instance 256 bits long, and the solutions, 256 bits. The primary receiver now has to use 256×256 obfuscated equations times their length to reach the level of a 256 bits security. Thus the initial senders bandwidth burden is 512 bits and the initial receivers bandwidth burden is 65536 bits.

The other extreme case, if we keep the number of parameterlines within the boundaries of the matrix, is 256 lines. Then the initial sender will have to use 256 bits for the seed and 256×256 bits for the number of equations times their solution length. The initial receiver can in this case return one obfuscated equation to describe a full 256 bits solutionline. In this case the initial senders bandwidth burden is 65792 bits and the receivers bandwidth burden is 256 bits.

As the function of bandwidth use is essentially multiplicative on each side the conclusion must be that the optimal number of parameterlines from a total bandwidth perspective in this case must be about \sqrt{256}=16. For a crude approach there is no need trying to elaborate further while an absolute solution can be brought about by a equation setup where the number of average, estimated tries of a hacker trying to intervene either on the sender side or the receiver side, is the same.

For a rectangular 256×256 matrix (with 16 parameterlines and 256 obfuscated equations) he needs to make it through almost 75% of a full combinatorial set while instant testing on the symmetrical scheme will only need in average 50% of a full set. This means that the number of bits needed per amount of information for one of the asymmetric keys sent should be about 16×0.50/0.75=less than 16 times larger than for a symmetric key of same security standard if the pseudo random generator seed is not considered.

1. Method for asymmetric on-the-fly building of a secret information pool, not easily recreatable for an interceptor, between two communicating data processing machine nodes without any prior secrets, over an insecure medium, the information pool can be used for instance, but not exclusively, as a session key for any subsequent symmetric encryption, the method is not dependent of prime numbers, discrete logarithms or obvious calculations of high computational cost, It comprises the following steps:
the first step, the initial sender completes a table of a defined number of equations, where each one expresses mathematica, logical or boolean equivalence between a variable set sum and a single solution;
the second step, to each variable on the side of the variable set is tied one single, hidden, multiplier parameter, which must be included for the equation to display equivalence with its solution;
the third step, the initial sender sends all equations, including their solutions, but excluding his hidden parameters, to a receiver;
the fourth step, the initial receiver now randomly chooses a number of equations, exclusive their parameters, and merge each variable therein together with the variables of corresponding positions, from all other, chosen equations, with a consensus operation, the receiver also merge the solutions of the chosen equations, together, He ends up with one obfuscated equation, comprising a variable set, and one single solution, by his coaction in the method at this point, the initial receiver is, by willful or random action, participating in the creation of the key necessary for the first natural language message of exchange between the initial sender and initial receiver, to be encrypted;
the fifth step, the initial receiver repeats the fourth step number of times with different random combinations of equations to generate an entire table of multiple, obfuscated equations;
the sixth step, the initial receiver sends back all the obfuscated equations to the initial sender, excluding their solutions, which he keeps for himself;
the seventh step, the initial sender uses his hidden parameters to solve the obfuscated equations from their variable set, as for any equation, by which action he reestablishes the entire table of obfuscated equations, including their solutions;
the eighth step, the solutions of the obfuscated equations now can be used as a secret information pool, common for the initial sender and the initial receiver.

2. Method according to claim 1, wherein each variable set is openly categorized together with others in scopes of equal length.

3. Method according to claim 1 or 2, wherein the first step, the fourth step and the seventh step XOR is used to add together each parameter enforced variable in a non carriage sum on the variable side of an equation, or for the fourth step orthogonally collected for each equation position, including solutions, compared with the first step and the seventh step, presuming the setup of all equations in a rectangular matrix.

4. Method according to claim 1 or 3, wherein the sixth step the initial receiver except for the thereby stated information also encloses an message, encrypted on the basis of the secret solutions of the equations.

5. Method according to claim 1 or 4, wherein the first step, the third step and the fourth step a common pseudorandom generator is used to produce and reproduce a larger set of equations from a smaller seed, which is transferred in the third step along with the solutions of the equations, in order to reduce the need for large data transfers during phase of the third step.

6. Method according to claim 1, 3 or 5, wherein the first step and eighth step multiple, from each other independent set of parameters are simultaneously tied to each equation in order to reduce the need for large data transfers during phase of the sixth step, then each equation will also have multiple, independent solutions, which are dealt with in a parallel, orthogonal approach during the fourth step presuming the setup of all equations in a rectangular matrix.

7. Method according to claim 1, 5 or 6 wherein the first step and the seventh step the parameter is 1 or corresponding representation for any included variable and 0 or corresponding representation for any omitted variable which is true for the variables of any equation in identical positions with respect to a specific parameter set and wherein the fourth step the parameter is 1 or corresponding representation for any included equation and 0 or corresponding representation for any omitted equation and the same operation is performed over the bits of the solution side.

8. Method according to claim 1 or 7, wherein each variable in any set, each solution and each parameter, is either 1 or 0 or corresponding representations of states or references with respect to the operation of addition modulo 2 and boolean/logically equivalence is stated for each one of the equations.

9. Method according to claim 1 or 8, wherein the solution is especially adapted for communication between more than 2 nodes.
